(19) United States
(12) Patent Application Publication
(10) Pub. No.: US 2025/0229757 A1
(43) Pub. Date: Jul. 17, 2025

(54) BRAKE ACTUATING ELEMENT COUPLING DEVICE

(71) Applicant: Robert Bosch GmbH, Stuttgart (DE)

(72) Inventors: Andreas Jakobsen, Bietigheim-Bissingen (DE); Christian Schleinig, Stuttgart (DE); Florian Haag, Ellhofen (DE); Martin Marquart, Reichenbach (DE); Nikolas Loeffelmann, Dielheim (DE)

(21) Appl. No.: 18/854,894

(22) PCT Filed: May 22, 2023
(86) PCT No.: PCT/EP2023/063615

§ 371 Date: Oct. 7, 2024

(30) Foreign Application Priority Data
May 30, 2022 (DE) 10 2022 205 426.1

(51) Int. Cl. B60T 13/62; B60T 7/02; B60T 7/12; B60T 13/14; B60T 13/74

(52) U.S. Cl. CPC B60T 13/62; B60T 7/02; B60T 7/12; B60T 13/143; B60T 13/745

(57) ABSTRACT

A brake actuating element coupling device. The coupling device includes a first input rod component which can be adjusted using a driver braking force out of its first starting position in a braking direction with respect to a brake master cylinder, a second input rod component, and a locking mechanism. The second input rod component is fastened via the locking mechanism, present in its locking functional mode, to the first input rod component in such a way that the second input rod component is also adjustable in the braking direction and the driver braking force can be transmitted to at least one adjustable piston of the brake master cylinder. If the locking mechanism is present in its non-locking functional mode, the second input rod component is adjustable relative to the first input rod component in the braking direction.

### FIELD

The present invention relates to a brake actuating element coupling device.

### BACKGROUND INFORMATION

German Patent Application No. DE 10 2018 200 374 A1 describes a brake booster which is designed with a first input piston component, a second input piston component and a valve body. The first input piston component can be adjusted from its starting position by an input travel in a braking direction by means of a driver braking force transmitted to it. The second input piston component is pushed away from the first input piston component in the braking direction by means of a compression spring. By means of a motor force transmitted to it, the valve body is adjusted from its starting position by a booster travel in the braking direction. In addition, a locking mechanism is formed on the brake booster in such a way that, as long as a differential travel between the booster travel and the input travel remains smaller than a specified limit differential travel, the second input piston component can be adjusted away from the first input piston component in the braking direction by means of the compression spring together with the valve body, while as soon as the differential travel exceeds the limit differential travel, the second input piston component is locked to the first input piston component.

### SUMMARY

The present invention relates to a brake actuating element coupling device.

The present invention provides an advantageous possibility for coupling a brake actuating element, such as a brake pedal, in such a way that a driver of a vehicle equipped with it can brake into a downstream master brake cylinder by actuating the brake actuating element. According to an example embodiment of the present invention, due to the advantageous design of the locking mechanism of the brake actuating element coupling device according to the present invention, the driver can trigger a braking movement of at least one adjustable piston of the master brake cylinder by means of the driver braking force exerted on the brake actuating element via the first input rod component and the second input rod component fastened thereto, so that the vehicle can easily be braked by means of driver-induced braking. In addition, the brake actuating element coupling device according to the present invention is advantageously suitable for carrying out autonomous brakings of the vehicle equipped therewith, in that during an adjustment of at least the second input rod component in the braking direction, a co-adjustment movement of the first input rod component is prevented due to the locking mechanism being in its non-locking functional mode. An unwanted pulling along or co-movement of the brake actuating element, such as the brake pedal, during autonomous braking is thus reliably prevented. However, as is clear from the following description, the driver can brake into the master brake cylinder by means of the driver braking force even during autonomous braking, after overcoming a negligibly short dead travel.

In an advantageous embodiment of the brake actuating element coupling device of the present invention, the second input rod component can be adjusted from its second starting position in the braking direction at most up to an end position, wherein the locking mechanism can be transferred from its non-locking functional mode to its locking functional mode in each position of the second input rod component from its second starting position up to its end position by means of the adjustment of the first input rod component from its first starting position by at least the specified first minimum adjustment travel. This means that even during strong autonomous braking the driver can further boost the braking by means of the driver braking force exerted on the brake actuating element.

According to an example embodiment of the present invention, preferably, for the second input rod component, which can be adjusted from its second starting position in the braking direction at most up to the end position as long as the locking mechanism remains in its non-locking functional mode, a transmission of force from the second input rod component to the first input rod component is prevented for each position of the second input rod component from its second starting position to its end position due to the locking mechanism being in its non-locking functional mode. This means that there is no risk of unwanted pulling along or co-movement of the first input rod component, or the brake actuating element attached to it, even if the second input rod component is adjusted from its second starting position by a large adjustment travel in the braking direction.

In a particularly advantageous embodiment of the brake actuating element coupling device of the present invention, the first input rod component has a rod portion aligned with the second input rod component, which portion, at least when the first input rod component is in its first starting position and the second input rod component is in its second starting position, projects into an inner cavity of the second input rod component, wherein the locking mechanism projects into the inner cavity of the second input rod component. By means of such a design of the first input rod component and the second input rod component, it can be ensured that a locking mechanism that can be produced at low cost is also transferred from its non-locking functional mode to its locking functional mode by adjusting the first input rod component from its first starting position by at least the specified first minimum adjustment travel.

For example, at least one sub-region of the rod portion is frustoconical with a diameter that decreases in the braking direction, wherein the locking mechanism has at least one wedge element that projects into the inner cavity and is arranged between an inner wall of the inner cavity and at least the frustoconical sub-region of the rod portion in such a way that, starting from an adjustment of the first input rod component from its first starting position by at least the specified first minimum adjustment travel, the at least one wedge element is pressed against the inner wall of the inner cavity by at least the frustoconical sub-region of the rod portion, whereby the locking mechanism is transferred from its non-locking functional mode to its locking functional mode. The locking mechanism design described here can be produced cost-effectively.

In a further advantageous embodiment of the brake actuating element coupling device of the present invention, the second input rod component has a rod portion aligned with the first input rod component, which portion, at least when the first input rod component is in its first starting position and the second input rod component is in its second starting position, protrudes into an inner cavity of the first input rod component, wherein the locking mechanism is attached to an outer edge of the inner cavity on the first input rod component or protrudes into the inner cavity of the first input rod component. Such a design of the first input rod component and the second input rod component can also be used to produce a cost-effective locking mechanism, which is transferred from its non-locking functional mode to its locking functional mode by adjusting the first input rod component from its first starting position by at least the specified first minimum adjustment travel.

Preferably, according to an example embodiment of the present invention, at least one sub-region of the inner cavity is formed with a frustoconical opening whose diameter increases in the braking direction, wherein the locking mechanism has at least one wedge element which projects into the frustoconical opening and is arranged between an inner wall of the frustoconical opening and the rod portion of the second input rod component in such a way that, starting from an adjustment of the first input rod component from its first starting position by at least the specified first minimum adjustment travel, the at least one wedge element is pressed against the rod portion of the second input rod component by the inner wall of the frustoconical opening, whereby the locking mechanism is transferred from its non-locking functional mode to its locking functional mode. This locking mechanism design can also be produced cost-effectively.

Alternatively, according to an example embodiment of the present invention, the locking mechanism attached to an outer edge of the inner cavity can have a wedging element through which the rod portion of the second input rod component protrudes and which is in a non-locking position when the first input rod component is in its first starting position, wherein, starting from an adjustment of the first input rod component from its first starting position by at least the specified first minimum adjustment travel, the wedging element is tilted from its non-locking position into its locking position, in which locking position the wedging element wedges against the rod portion of the second input rod component, whereby the locking mechanism is transferred from its non-locking functional mode into its locking functional mode. The locking mechanism described here can also be produced cost-effectively.

Preferably, according to an example embodiment of the present invention, the locking mechanism can also be transferred from its locking functional mode into its non-locking functional mode by adjusting the first input rod component against the braking direction back into its first starting position. In this way, immediately after driver-induced braking has ended, autonomous braking can be carried out at once without this triggering a pulling along or co-adjustment of the brake actuating element.

For example, when the first input rod component is moved against the braking direction back to its first starting position, the wedging element in its locking position can meet a stop in such a way that the wedging element is moved from its locking position back to its non-locking position, whereby the locking mechanism is transferred from its locking functional mode to its non-locking functional mode. This is structurally easy to realize.

In a further advantageous embodiment of the present invention, the brake actuating element coupling device is designed as a brake booster and comprises a booster piston which is connected directly or indirectly to an actuator of the brake actuating element coupling device in such a way that the booster piston can be adjusted in the braking direction by means of a booster force of the actuator transmitted to it, wherein the booster piston, which is adjusted by at least a specified second minimum adjustment travel in the braking direction, mechanically contacts the second input rod component in such a way that the second input rod component is also adjustable in the braking direction together with the booster piston. The actuator, such as an electric motor, can therefore be used not only to provide power assistance for driver-induced braking, but also to effect autonomous braking, for which purpose the second input rod component is adjusted together with the booster piston, while the first input rod component remains in its first starting position. This ensures that during the autonomous braking effected by the actuator, the brake actuating element remains in its non-actuated position.

### BRIEF DESCRIPTION OF THE DRAWINGS

Further features and advantages of the present invention will be explained in the following with reference to the figures.

FIGS. 1A-1C, 1Da, and 1Db show schematic representations of a first example embodiment of the brake actuating element coupling device of the present invention.

FIG. 2 shows a schematic representation of a second example embodiment of the brake actuating element coupling device.

FIG. 3 shows a schematic representation of a third example embodiment of the brake actuating element coupling device, according to the present invention.

FIGS. 4A to 4D show schematic representations of a fourth embodiment of the brake actuating element coupling device, according to the present invention.

### DETAILED DESCRIPTION OF EXAMPLE EMBODIMENTS

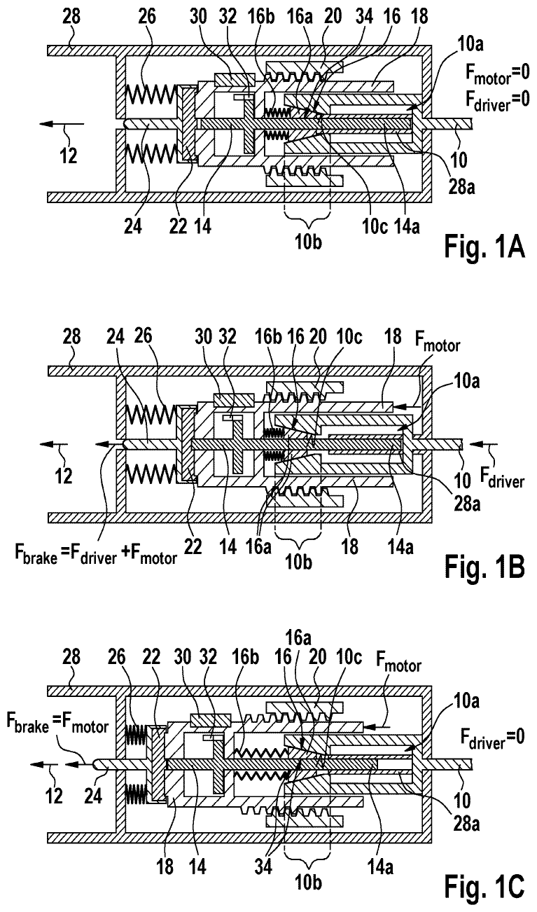

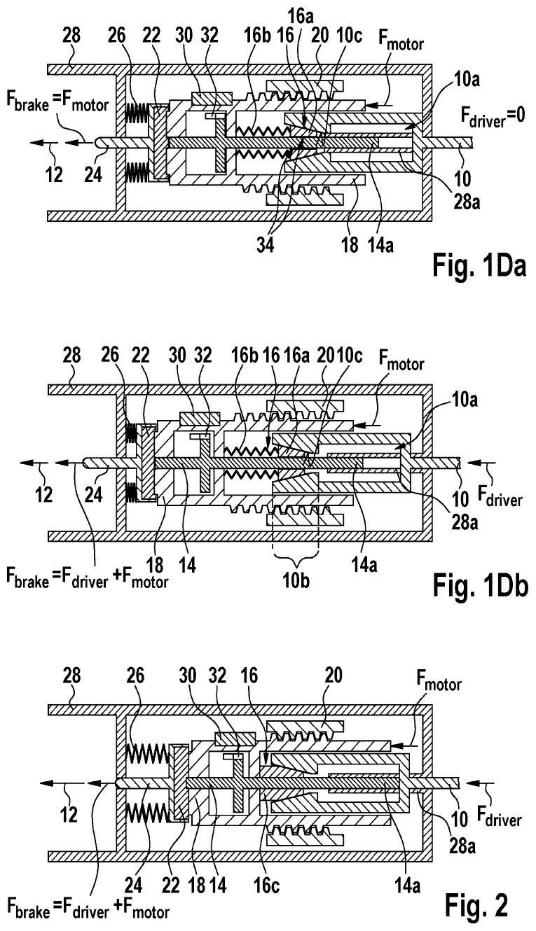

FIGS. 1A to 1Db show schematic representations of a first embodiment of the brake actuating element coupling device.

A brake actuating element (not shown) can be mounted on a vehicle/motor vehicle by means of the brake actuating element coupling device shown schematically in FIGS. 1A to 1Db. The brake actuating element can be understood to be a brake pedal, for example. The brake actuating element can be part of the brake actuating element coupling device, or can be a brake actuating element connected thereto externally. The brake actuating element coupling device has a first input rod component 10 to which the brake actuating element can be or is connected. The brake actuating element can be connected to the first input rod component 10 either directly or indirectly, in particular via at least one pedal rod. The direct or indirect connection of the brake actuating element to the first input rod component 10 can be or is realized in such a way that a driver braking force F_{driver} exerted by a driver on the brake actuating element can be or is transmitted to the first input rod component 10, and the first input rod component 10 can be or is adjusted by means of the transmitted driver braking force F_{driver} from its so-called first starting position in a braking direction 12 relative to a master brake cylinder (not shown). The master brake cylinder, located in the braking direction 12 in relation to the first input rod component 10, can be part of the device or can be an external master brake cylinder. The first starting position of the first input rod component 10 is preferably to be understood as a position from which the first input rod component 10 can be adjusted only in the braking direction 12 and not in a direction opposite to the braking direction 12. In particular, the first starting position can be a position of the first input rod component 10 in which the first input rod component 10 is at a driver braking force F_{driver} equal to zero, due for example to at least one restoring spring force.

In addition to the first input rod component 10, the brake actuating element coupling device also has a second input rod component 14. A second starting position can also be defined for the second input rod component 14, from which position the second input rod component 14 can be adjusted in the braking direction 12 at most as far as a so-called end position of the second input rod component 14. The second starting position can in particular be understood to mean a position of the second input rod component 14 from which the second input rod component 14 can be adjusted only in the braking direction 12 and not in the direction opposite to the braking direction 12.

Preferably, the second input rod component 14 is supported, for example by means of at least one restoring spring force, such that the second input rod component 14 is in the second starting position at a driver braking force F_{driver} equal to zero and, if the brake actuating element coupling device also comprises an actuator (described below), at a booster force Fₘₒₜₒᵣ of the actuator equal to zero. The end position can be understood as a position of the second input rod component 14 from which the second input rod component 14 cannot be adjusted further in the braking direction 12 due to a design of the brake actuating element coupling device.

Moreover, a locking mechanism 16 is formed on the brake actuating element coupling device in such a way that the second input rod component 14 is attached to the first input rod component 10 via the locking mechanism 16 in its locking functional mode, in such a way that the second input rod component 14 can be or is co-adjusted together with the first input rod component 10 (adjusted by means of the driver braking force F_{driver}) in the braking direction 12. When the locking mechanism 16 is in its locking functional mode, the driver braking force F_{driver} is therefore transmissible/transmitted from the first input rod component 10 to the second input rod component 14 and from the second input rod component 14 directly or indirectly to at least one adjustable piston of the master brake cylinder. In contrast, if the locking mechanism 16 is in its non-locking functional mode, the second input rod component 14 is not fastened/locked to the first input rod component 10 and can therefore be adjusted relative to the first input rod component 10 in the braking direction 12. The free adjustability of the second input rod component 14 relative to the first input rod component 10 when the locking mechanism 16 is in its non-locking functional mode means that the second input rod component 14 can be freely adjusted between its second starting position and its end position in relation to the first input rod component 10 in the braking direction 12 without this triggering a co-movement of the first input rod component 10.

The locking mechanism 16 thus enables a connection of the two input rod components 10 and 14 when the locking mechanism 16 is in its locking functional mode and a decoupling of the second input rod component 14 from the first input rod component 10 when the locking mechanism 16 is in its non-locking functional mode. When the locking mechanism 16 is in its non-locking functional mode, the second input rod component 14 can therefore be adjusted relative to the first input rod component 10 in the braking direction 12 without this triggering a pulling along of the first input rod 10, or of the brake actuating element directly or indirectly connected to the first input rod 10.

In addition, the locking mechanism 16 is designed such that the locking mechanism 16 can be or is transferred from its non-locking functional mode to its locking functional mode by adjusting the first input rod component 10 from its first starting position by at least a specified first minimum adjustment travel. As is clear from the description of this embodiment, the first minimum adjustment travel can be a first minimum adjustment travel dependent on a current position of the second input rod component 14 (between its second starting position and its end position). Alternatively, however, the first minimum adjustment travel can also be independent of a current position of the second input rod component 14, i.e., can be a constant first minimum adjustment travel.

This means that whenever the driver requests driver-induced braking of the vehicle by means of the non-zero driver braking force F_{driver} exerted on the brake actuating element, the locking mechanism 16 is in its locking functional mode and the driver braking force F_{driver} can be reliably transmitted to the at least one adjustable piston of the master brake cylinder via the two input rod components 10 and 14 fastened to one another. In addition, during non-actuation of the brake actuating element by the driver, when the first input rod component 10 is in its first starting position, the second input rod component 14, which is decoupled from the first input rod component 10 when the locking mechanism 16 is in its non-locking functional mode, can be adjusted relative to the first input rod component 10 in the braking direction 12 without this triggering a pulling along of the brake actuating element. Particularly during autonomous braking of the vehicle, the second input rod component 14 can therefore be adjusted relative to the first input rod component 10 without the driver being irritated or hindered by a pulling along of the brake actuating element. Autonomous braking of the vehicle can be understood to be braking which is not requested by the driver but by an automatic speed control system of the vehicle. Autonomous braking of the vehicle can also be referred to as automatic braking or as functional braking. For example, an adaptive cruise control system, an emergency braking system, or a fully automatic driving program can request the autonomous braking.

Preferably, the locking mechanism 16 can be or is transferred from its non-locking functional mode to its locking functional mode at each position of the second input rod component 14 from its second starting position to its end position by means of the adjustment of the first input rod component 10 from its first starting position by at least the specified first minimum adjustment travel. The driver braking force F_{driver} exerted on the brake actuating element can thus also be transmitted to the at least one adjustable piston of the master brake cylinder via the input rod components 10 and 14, which are fastened together, even during autonomous braking when the second input rod component 14 is not in its second starting position. Preferably, the locking mechanism 16 is additionally designed in such a way that the locking mechanism 16 can be or is transferred from its locking functional mode into its non-locking functional mode by adjusting the first input rod component 10 against the braking direction 12 back into its first starting position. This automatically ensures that the locking mechanism 16 is back in its non-locking function mode after the end of driver-induced braking.

As an advantageous development, the brake actuating element coupling device of FIGS. 1A to 1Db is designed as a brake booster which is arranged upstream of the interacting master brake cylinder. For this purpose, the brake actuating element coupling device comprises a booster piston 18 which is connected directly or indirectly to an actuator (not shown) of the brake actuating element coupling device in such a way that the booster piston 18 can be adjusted/is adjusted in the braking direction 12 by means of a booster force Fₘₒₜₒᵣ of the actuator transmitted to it. The actuator can be an electric motor, for example. However, it is pointed out that the practicability of the brake booster is not limited to an electromechanical brake booster. The booster force Fₘₒₜₒᵣ of the actuator transmitted to the booster piston 18 can also be transmitted directly or indirectly to the at least one adjustable piston of the master brake cylinder. The actuator can therefore be used not only to provide power assistance to the driver during driver-induced braking, but also to bring about autonomous braking of the vehicle.

Furthermore, in the brake actuating element coupling device described herein, the booster piston 18, which is adjusted by at least a specified second minimum adjustment travel in the braking direction 12, mechanically contacts the second input rod component 14 in such a way that the second input rod component 14 is co-adjustable or co-adjusted together with the booster piston 18 in the braking direction 12. Due to the advantageous design of the locking mechanism 16 described above, however, when the first input rod component 10 is in its first starting position, no co-movement of the brake actuating element triggered by the joint adjustment of the second input rod component 14 and the booster piston 18 has to be accepted. As long as the locking mechanism 16 remains in its non-locking functional mode, a transmission of force from the second input rod component 14 to the first input rod component 10 is prevented in each position of the second input rod component 14 from its second starting position to its end position, due to the locking mechanism 16 being in its non-locking functional mode. This also eliminates the conventional risk that an object, such as a driver's foot, could become trapped during rapid and strong autonomous braking of the vehicle due to a carried-along movement of the brake actuating element triggered in the prior art. The embodiment of the brake actuating element coupling device described here thus realizes a better safety standard for the driver, although it can nevertheless be used to effect autonomous braking of the vehicle. Furthermore, when the brake actuating element coupling device described here is used, there is no longer the conventional need to attach an anti-trap protection to the brake actuating element, so that costs can be saved.

By way of example only, in the brake actuating element coupling device described here the booster piston 18 is designed as a spindle, which is adjusted in the braking direction 12 by means of a nut 20 set into rotational movement by the electric motor acting as an actuator. The two input rod components 10 and 14 are located in an inner cavity of the booster piston 18. A reaction disk 22 against which the booster piston 18 and/or a portion of the second input rod component 14 protruding from the inner cavity of the booster piston 18 (can) press is located in the braking direction 12 relative to the booster piston 18 and the two input rod components 10 and 14. The reaction disk 22 lies in a recess of an output rod 24, which is supported by the master brake cylinder or a housing 28 of the brake actuating element coupling device by means of at least one restoring spring 26. However, it is to be noted that the connection of the second input rod component 14 and the booster piston 18 to the at least one adjustable piston of the master brake cylinder by means of components 22, 24 and 26, as shown schematically in FIGS. 1A to 1Db, is to be understood by way of example only. The linear movement sensor 30 shown in FIGS. 1A to 1Db, which is fastened to the booster piston 18 and is designed to detect a relative movement of a magnet 32 fastened to the second input rod component 14 in relation to the linear movement sensor 30, is also only an optional component of the brake actuating element coupling device.

In the embodiment of FIGS. 1A to 1Db, the second input rod component 14 has a rod portion 14a aligned with the first input rod component 10, which portion projects into an inner cavity 10a of the first input rod component 10 at least when the first input rod component 10 is in its first starting position and the second input rod component 14 is in its second starting position. Preferably, even when the first input rod component 10 is in its first starting position, the rod portion 14a projects into the inner cavity 10a in each position of the second input rod component 14 from its second starting position to its end position. At least one sub-region 10b of the inner cavity 10a is designed with a frustoconical opening, whose diameter increases in the braking direction 12 and which is delimited by an inner wall 10c acting as a sliding surface. The locking mechanism 16 has at least one wedge element 16a which projects into the frustoconical opening and is arranged between the inner wall 10c of the frustoconical opening and the rod portion 14a of the second input rod component 14. The at least one wedge element 16a can, for example, be pressed in the direction opposite the braking direction 12 by means of at least one tension and/or compression spring 16b. By way of example only, in the embodiment of FIGS. 1A to 1Db the at least one wedge element 16a is supported on the booster piston 18 by means of the at least one tension and/or compression spring 16b. Alternatively, the at least one wedge element 16a can also be supported on a housing component of the housing 28 by means of the at least one tension and/or compression spring 16b.

FIG. 1A shows the brake actuating element coupling device in the rest position, i.e., with a driver braking force F_{driver} equal to zero and a booster force Fₘₒₜₒᵣ equal to zero. When the first input rod component 10 is in its first starting position, the at least one wedge element 16a projects into the frustoconical opening only to an extent such that there is still an intermediate gap 34 between the rod portion 14a of the second input rod component 14 and the at least one wedge element 16a. For example, while the first input rod component 10 is in its first starting position, a housing component 28a of the housing 28 can counteract a further penetration of the at least one wedge element 16a into the frustoconical opening. As long as the at least one wedge element 16a protrudes into the frustoconical opening only so far that the intermediate gap 34 still remains between the rod portion 14a of the second input rod component 14 and the at least one wedge element 16a, the second input rod component 14 can be adjusted relative to the first input rod component 10 without triggering a pulling along of the first input rod component 10. The locking mechanism 16 is therefore in its non-locking functional mode at a driver braking force F_{driver} equal to zero when the first input rod component 10 is in its first starting position, due to the intermediate gap 34 between the rod portion 14a and the at least one wedge element 16a.

FIG. 1B shows the brake actuating element coupling device during driver-induced braking, i.e., while the driver is exerting a non-zero driver braking force F_{driver} on the brake actuating element. It can be seen that starting from an adjustment of the first input rod component 10 from its first starting position by at least the specified first minimum adjustment travel, the at least one wedge element 16a is pressed against the rod portion 14a of the second input rod component 14 by the inner wall 10c of the frustoconical opening in such a way that the first input rod component 10 is clamped against the second input rod component 14 due to the absence of an intermediate gap, whereby the locking mechanism 16 is transferred from its non-locking functional mode to its locking functional mode. Due to the adjustment together of the two input rod components 10 and 14, fastened to one another via the locking mechanism 16 in its locking functional mode, the driver braking force F_{driver} is reliably transmitted to the at least one adjustable piston of the master brake cylinder. During driver-induced braking, the driver can still be assisted by a non-zero booster force Fₘₒₜₒᵣ of the actuator/electric motor. In this case, a braking force F_{brake} transmitted to the at least one adjustable piston of the master brake cylinder is the sum of the driver braking force F_{driver} and the booster force Fₘₒₜₒᵣ.

FIG. 1C shows the brake actuating element coupling device during autonomous braking, i.e., when a brake pressure buildup is effected at a driver braking force F_{driver} equal to zero by means of a booster force Fₘₒₜₒᵣ not equal to zero. Due to the locking mechanism 16 being in its non-locking functional mode, the second input rod component 14 can be adjusted together with the booster piston 18 in the braking direction 12 by means of the booster force Fₘₒₜₒᵣ, while the first input rod component 10 remains in its first starting position. Thus, during autonomous braking there is also no co-adjustment movement of the brake actuating element, which is not actuated by the driver.

FIGS. 1Da and 1Db also show the brake actuating element coupling device during autonomous braking. However, while FIG. 1Da shows a time interval of autonomous braking before the driver makes a further braking request by actuating the brake actuating element, the driver additionally brakes into the master brake cylinder with a driver braking force F_{driver} not equal to zero during the time interval of autonomous braking shown schematically in FIG. 1Db. As can be seen in FIG. 1Db, during autonomous braking the driver can still transfer the locking mechanism 16 from its non-locking functional mode to its locking functional mode despite the second input rod component 14 being adjusted from its second starting position. The dead travel that the driver has to overcome to take over the driving is comparatively short. For each position of the second input rod component 14 between its second starting position and its end position, the first minimum adjustment travel can be less than or equal to 8 mm (millimeters), in particular less than or equal to 5 mm (millimeters), specifically less than or equal to 3 mm (millimeters), also less than or equal to 1.5 mm (millimeters).

FIG. 2 shows a schematic representation of a second embodiment of the brake actuating element coupling device.

The only difference from the above-explained embodiment of FIG. 1A to 1D is that the brake actuating element coupling device of FIG. 2 has at least one wedge element 16c made of an elastic polymer. The support of the at least one wedge element 16c by means of at least one tension and/or compression spring 16b can therefore also be dispensed with.

With respect to further features of the brake actuating element coupling device of FIG. 2 and its advantages, reference is made to the above-explained embodiments of FIG. 1A to 1D.

FIG. 3 shows a schematic representation of a third embodiment of the brake actuating element coupling device.

In the brake actuating element coupling device of FIG. 3, the locking mechanism 16 has a wedging element 16d which is fastened to an outer edge of the inner cavity 10a of the first input rod component 10. The wedging element 16d can be inexpensively made of an elastic material. The wedging element 16d is preferably rotationally symmetrical with respect to a longitudinal axis extending through the inner cavity 10a of the first input rod component 10. As can be seen in FIG. 3, the rod portion 14a of the second input rod component 14 projects through the wedging element 16d of the locking mechanism 16.

FIG. 3 shows the brake actuating element coupling device in the rest position, i.e., when both input rod components 10 and 14 are in their starting positions due to a driver braking force F_{driver} equal to zero and an assistance force Fₘₒₜₒᵣ equal to zero. When the first input rod component 10 is in its first starting position, the wedging element 16d is moreover in a non-locking position, which is why the second input rod component 14 can be adjusted relative to the first input rod component 10 in the braking direction 12 despite its rod portion 14a projecting through the wedging element 16d. On the other hand, starting from an adjustment of the first input rod component 10 from its first starting position by at least the specified first minimum adjustment travel, the wedging element 16d is tilted from its non-locking position into its locking position, in which the wedging element 16d wedges against the rod portion 14a of the second input rod component 14. In this way, the locking mechanism 16 is transferred from its non-locking functional mode into its locking functional mode.

In the embodiment of FIG. 3, the first minimum adjustment travel is independent of a current position of the second input rod component 14, i.e., a constant first minimum adjustment travel. The first minimum adjustment travel can be less than or equal to 5 mm (millimeters), in particular less than or equal to 3 mm (millimeters), specifically less than or equal to 1 mm (millimeter).

As can also be seen in FIG. 3, the wedging element 16d meets a stop 28b, preferably a stop 28b formed on the housing 28, when the first input rod component 10 is moved against the braking direction 12 back to its first starting position. In this way, the wedging element 16d in its locking position is moved back from its locking position to its non-locking position, whereby the locking mechanism 16 is transferred from its locking functional mode to its non-locking functional mode.

With respect to further features of the brake actuating element coupling device of FIG. 3 and its advantages, reference is made to the embodiment of FIG. 1A to 1D described above.

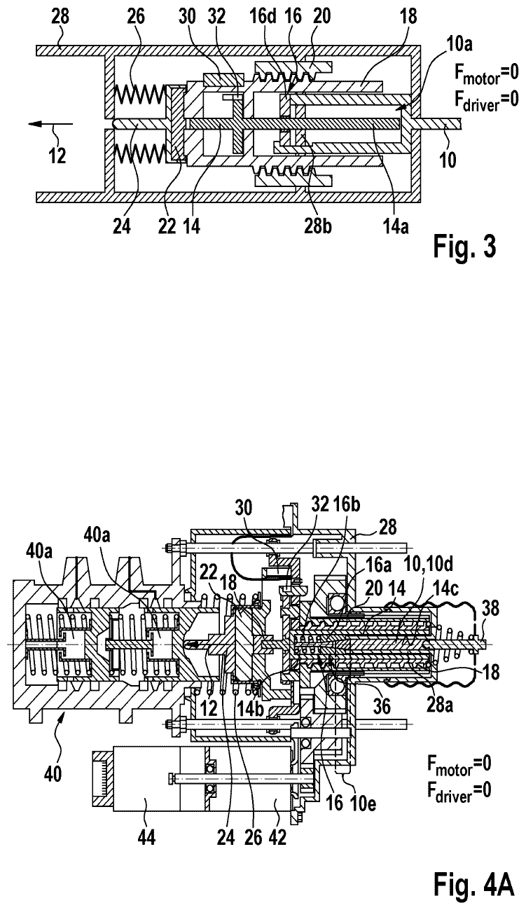

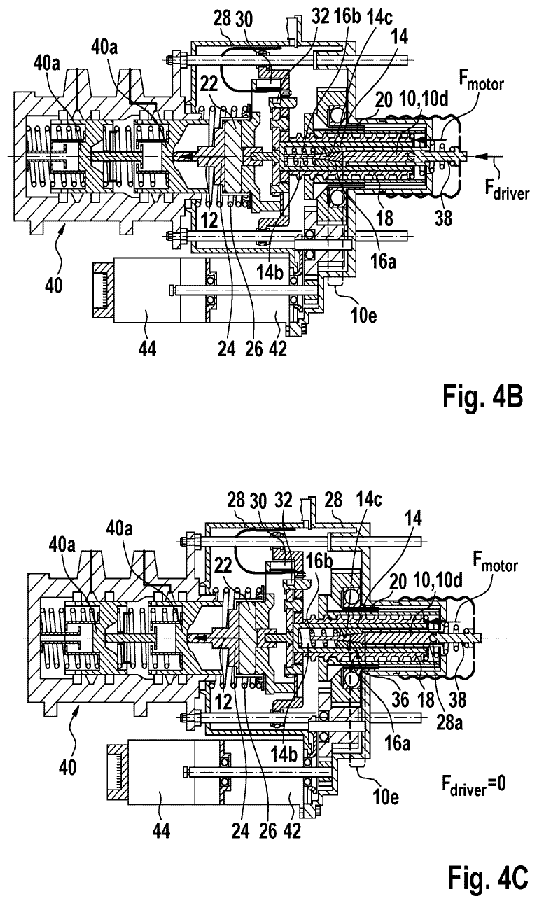

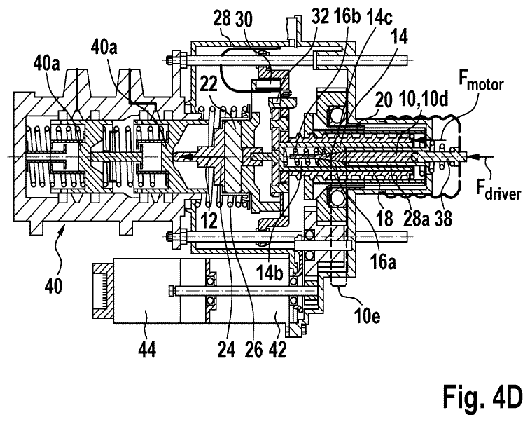

FIG. 4A to 4D show schematic representations of a fourth embodiment of the brake actuating element coupling device.

In contrast to the embodiments described above, in the brake actuating element coupling device of FIG. 4A to 4D, the first input rod component 10 has a rod portion 10d which is aligned with the second input rod component 14 and which, at least when the first input rod component 10 is in its first starting position and the second input rod component 14 is in its second starting position, projects into an inner cavity 14b of the second input rod component 14. Preferably, even when the first input rod component 10 is in its first starting position, the rod portion 10d projects into the inner cavity 14b in each position of the second input rod component 14 from its second starting position to its end position. The locking mechanism 16, which comprises at least one wedge element 16a, also protrudes into the inner cavity 14b of the second input rod component 14. In addition, at least one sub-region 10e of the rod portion 10d is frustoconical in shape with a diameter decreasing in the braking direction 12, wherein the at least one wedge element 16a projecting into the inner cavity 14b is arranged between an inner wall 14c of the inner cavity 14b and at least the frustoconical sub-region 10e of the rod portion 10d.

FIG. 4A shows the brake actuating element coupling device in the rest position, i.e., with a driver braking force F_{driver} equal to zero and a booster force Fₘₒₜₒᵣ equal to zero. While the first input rod component 10 is in its first starting position, the at least one wedge element 16a is pressed slightly in the braking direction 12 by the housing component 28a of the housing 28, for which reason there is still an intermediate gap 36 between the inner wall 14c of the inner cavity 14b and the at least one wedge element 16a. Thus, at a driver braking force Fₘₒₜₒᵣ equal to zero, when the first input rod component 10 is in its first starting position the locking mechanism 16 shown in FIG. 4A to 4D is also in its non-locking functional mode due to the intermediate gap 36 between the inner wall 14c of the inner cavity 14b and the at least one wedge element 16a.

FIG. 4B shows the brake actuating element coupling device during an actuation of the brake actuating element by the driver. It can be seen that, starting from an adjustment of the first input rod component 10 from its first starting position by at least the specified first minimum adjustment travel, the at least one wedge element 16a is pressed against the inner wall 10c of the inner cavity 14b by at least the frustoconical sub-region 10e of the rod portion 10d in such a way that, due to the absence of an intermediate gap 36 between the inner wall 14c and the at least one wedge element 16a, the locking mechanism 16 is transferred from its non-locking functional mode to its locking functional mode.

FIG. 4C shows the brake actuating element coupling device during autonomous braking, i.e., when a brake pressure buildup is achieved with a driver braking force F_{driver} equal to zero by means of a booster force Fₘₒₜₒᵣ not equal to zero. Due to the intermediate gap 36 between the inner wall 14c and the at least one wedge element 16a, the second input rod component 14 can be adjusted together with the booster piston 18 in the braking direction 12 by means of the booster force Fₘₒₜₒᵣ, while the first input rod component 10 remains in its first starting position.

In the operating situation shown in FIG. 4D, the driver additionally brakes into the master brake cylinder during autonomous braking with a driver braking force F_{driver} not equal to zero. Although the second input rod component 14 is already adjusted from its second starting position by means of a non-zero booster force Fₘₒₜₒᵣ at the start of the driver's braking, the driver can quickly and easily transfer the locking mechanism 16 from its non-locking functional mode to its locking functional mode.

A pedal rod 38, the master brake cylinder 40 with its at least one adjustable piston 40a, the electric motor 42, and a control device 44 for controlling at least the electric motor 42 are shown in FIG. 4A to 4D as (optional) components of the brake actuating element coupling device, by way of example only.

All brake actuating element coupling devices described above realize a mechanical concept of a decouplable input rod device, wherein a frictional connection between its input rod components 10 and 14 can be selectively connected or disconnected. All brake actuating element coupling devices have in common that when there is driver-induced braking, the driver can brake into the master brake cylinder 40 (i.e., driver takeover) after overcoming a minimized dead travel, whereas in the case of autonomous braking the brake actuating element is decoupled from the master brake cylinder 40. However, even during autonomous braking there can still be a transmission of force from the first input rod component 10 to the second input rod component 14 even if the second input rod component 14 has already been adjusted from its second starting position by an adjustment travel not equal to zero. The length of the adjustment travel by which the second input rod component 14 is adjusted from its second starting position has (substantially) no influence on the dead travel to be overcome for the driver takeover. While braking during autonomous braking, the driver will notice a slightly changed characteristic curve, but usually will not perceive this as disturbing. All of the brake actuating element coupling devices described above also have a mechanical fallback level which allows the driver to brake quickly into the downstream master brake cylinder 40 using the driver braking force, even in the event of a power failure.

It is to be noted that the usability of the brake actuating element coupling devices described above is not limited to any specific type of vehicle/motor vehicle equipped therewith. The usability of these brake actuating element coupling devices is also not limited to a specific type of brake system equipped or interacting therewith.

In the brake actuating element coupling devices whose first minimum adjustment travel is dependent on a current position of the second input rod component 14, for each position of the second input rod component 14 between its second starting position and its end position, the first minimum adjustment travel can be less than or equal to 8 mm (millimeters), in particular less than or equal to 5 mm (millimeters), specifically less than or equal to 3 mm (millimeters), also less than or equal to 1.5 mm (millimeters). Alternatively, the first minimum adjustment travel, which is constant or is independent of a current position of the second input rod component 14, can be less than or equal to 5 mm (millimeters), in particular less than or equal to 3 mm (millimeters), specifically less than or equal to 1 mm (millimeter).

1-11. (canceled)

12. A brake actuating element coupling device, comprising:
a first input rod component which is connected or can be connected directly or indirectly to a brake actuating element in such a way that the first input rod component is adjustable, using a driver braking force exerted on the brake actuating element and transmitted to the first input rod component, from a first starting position in a braking direction to a master brake cylinder that is part of the device or is external;
a second input rod component; and
a locking mechanism, wherein the second input rod component is fastened to the first input rod component via the locking mechanism, which is in a locking functional mode, in such a way that the second input rod component can be adjusted together with the first input rod component in the braking direction and the driver braking force can be transmitted directly or indirectly from the second input rod component to at least one adjustable piston of the master brake cylinder, and, when the locking mechanism is in a non-locking functional mode, the second input rod component is adjustable relative to the first input rod component in the braking direction;
wherein the locking mechanism is configured such that the locking mechanism can be transferred from the non-locking functional mode to the locking functional mode by an adjustment of the first input rod component from the first starting position by at least a specified first minimum adjustment travel.

13. The brake actuating element coupling device according to claim 12, wherein the second input rod component can be adjusted from a second starting position in the braking direction at most up to an end position, and wherein the locking mechanism can be transferred from the non-locking functional mode to the locking functional mode in each position of the second input rod component from the second starting position up to its end position by the adjustment of the first input rod component from the first starting position by at least the specified first minimum adjustment travel.

14. The brake actuating element coupling device according to claim 13, wherein the second input rod component can be adjusted from the second starting position in the braking direction at most up to the end position and wherein, as long as the locking mechanism remains in the non-locking functional mode, a transmission of force from the second input rod component to the first input rod component is prevented for each position of the second input rod component from the second starting position to the end position due to the locking mechanism being in the non-locking functional mode.

15. The brake actuating element coupling device according to claim 13, wherein the first input rod component has a rod portion which is aligned with the second input rod component and which, at least when the first input rod component is in the first starting position and the second input rod component is in a second starting position, projects into an interior cavity of the second input rod component, and wherein the locking mechanism projects into the interior cavity of the second input rod component.

16. The brake actuating element coupling device according to claim 14, wherein at least one sub-region of the rod portion is frustoconical in shape, with a diameter decreasing in the braking direction, and wherein the locking mechanism has at least one wedge element which projects into the inner cavity and is arranged between an inner wall of the inner cavity and at least the frustoconical sub-region of the rod portion in such a way that, starting from an adjustment of the first input rod component from the first starting position by at least the specified first minimum adjustment travel, the at least one wedge element is pressed against the inner wall of the inner cavity by at least the frustoconical sub-region of the rod portion, whereby the locking mechanism is transferred from the non-locking functional mode to the locking functional mode.

17. The brake actuating element coupling device according to claim 14, wherein the second input rod component has a rod portion which is aligned with the first input rod component and which, at least when the first input rod component is in these first starting position and the second input rod component is in the second starting position, projects into an inner cavity of the first input rod component, and wherein the locking mechanism is attached to the first input rod component at an outer edge of the inner cavity of the first input rod or projects into the inner cavity of the first input rod component.

18. The brake actuating element coupling device according to claim 17, wherein at least one sub-region of the inner cavity is formed with a frustoconical opening whose diameter increases in the braking direction, and wherein the locking mechanism has at least one wedge element which projects into the frustoconical opening and is arranged between an inner wall of the frustoconical opening and the rod portion of the second input rod component in such a way that, starting from an adjustment of the first input rod component from the first starting position by at least the specified first minimum adjustment travel, the at least one wedge element is pressed against the rod portion of the second input rod component by the inner wall of the frustoconical opening, whereby the locking mechanism is transferred from the non-locking functional mode into the locking functional mode.

19. The brake actuating element coupling device according to claim 17, wherein the locking mechanism fastened to an outer edge of the inner cavity includes a wedging element through which the rod portion of the second input rod component protrudes, and which is in a non-locking position when the first input rod component is in the first starting position, and wherein starting from an adjustment of the first input rod component from the first starting position by at least the specified first minimum adjustment travel, the wedging element is tilted from the non-locking position into a locking position, in which locking position the wedging element wedges against the rod portion of the second input rod component, whereby the locking mechanism is transferred from the non-locking functional mode into the locking functional mode.

20. The brake actuating element coupling device according to claim 19, wherein the locking mechanism can be transferred from the locking functional mode into the non-locking functional mode by adjusting the first input rod component against the braking direction back into the first starting position.

21. The brake actuating element coupling device according to claim 20, wherein the wedging element, in the locking position, meets a stop when the first input rod component is adjusted against the braking direction back into the first starting position, in such a way that the wedging element is moved from the locking position back into the non-locking position, whereby the locking mechanism is transferred from the locking functional mode into the non-locking functional mode.

22. The brake actuating element coupling device according to claim 12, wherein the brake actuating element coupling device is a brake booster and includes a booster piston which is connected directly or indirectly to an actuator of the brake actuating element coupling device in such a way that the booster piston can be adjusted in the braking direction by a booster force of the actuator transmitted thereto, and wherein the booster piston adjusted by at least a specified second minimum adjustment travel in the braking direction mechanically contacts the second input rod component in such a way that the second input rod component is co-adjustable in the braking direction together with the booster piston.
